(19) United States
(12) Patent Application Publication
(10) Pub. No.: US 2013/0100066 A1
(43) Pub. Date: Apr. 25, 2013

(54) MULTI-TOUCH CAPABLE SINGLE LAYER CAPACITIVE TOUCH PANEL

(71) Applicant: Jerry L. Doorenbos, Tucson, AZ (US)

(72) Inventor: Jerry L. Doorenbos, Tucson, AZ (US)

(73) Assignee: Texas Instruments Incorporated, Dallas, TX (US)

(21) Appl. No.: 13/281,259

(22) Filed: Oct. 25, 2011

(51) Int. Cl. G06F 3/045

(52) U.S. Cl. 345/174

(57) ABSTRACT

An apparatus is provided, which has a touch panel, an interconnect, and a touch panel controller. The touch panel has a plurality of sensors arranged in a plurality of rows and columns. Each row has a row electrode that extends across a portion of the touch screen and that is coupled to a row pad located along the periphery of the touch panel through a routing network, and each column has a plurality of column electrodes that are interleaved with at least one of the row electrodes and that are each coupled to a column pad located along the periphery of the touch panel through the routing network. The interconnect is secured to the touch panel and is coupled to each column pad and each row pad. The touch screen controller has an interface that is coupled to the interconnect and a control circuit that is coupled to the interface.

### TECHNICAL FIELD

The invention relates generally to a touch panel and, more particularly, to a single layer touch panel having multi-touch capability.

### BACKGROUND

Turning to FIGS. 1 and 2, an example of a convention system 100 can be seen. System 100 generally comprise a touch panel 102 and touch screen controller 104. The touch panel 102 has an array of sensors formed by a set of column electrodes (i.e., electrode 105), where each electrode of each column is coupled together by a strip electrode (i.e., strip electrode 107), and a set of row electrodes (i.e., electrode 109), where each electrode of each row is coupled together by a strip electrode (i.e., strip electrode 107). The strip electrodes for each column (i.e., strip electrode 107) are then coupled to the interface or I/F 106 of the touch panel controller 104 by terminals X-1 to X-N, while the strip electrodes for each row (i.e., strip electrode 109) are coupled to the interface 106 by terminals Y-1 to Y-M. The interface 106 is able to communicate with the control circuit 108. As shown in greater detail in FIG. 2, the interface 106 is generally comprised of a multiplexer or mux 202 and an exciter 204.

In operation, the interface 106 (which is usually controlled by the control circuit 108) selects and excites columns of electrodes (i.e., electrode 103) and “scans through” the rows of row electrodes (i.e., electrode 105) so that a touch position from a touch event can be resolved. As an example, interface 204 can exciting two adjacent columns through terminals X-j and X-(j+1) with excitation signals EXCITE[j] and EXCITE[j+1], and interface 106 receives a measurement signal from a row associated with terminal Y-i. When an object (i.e., finger) is in proximity to the touch panel (which is generally considered to be a touch event), there is a change in capacitance, and the controller 108 is able to resolve the position of the touch event.

Conventional touch panels (such as touch panel 102), though, usually have a complex structure. Usually, the column and row electrodes (i.e., electrodes 105 and 109) are formed in two separate layers with a dielectric layer formed therebetween. Even though these conductive layers which form the electrodes (i.e., electrodes 105 and 109) are generally transparent to visible spectrum light (i.e., light having a wavelength from about 380 nm to about 750 nm) there is some opacity and losses as light is projected through the touch panel 102. This means that there is lower efficiency (because of the lower transparency) with dual (or more) layer touch panels (such as touch panel 102) compared to single layer touch panels.

Most conventional single layer touch panels, though, are costly and/or cumbersome. Conventional single layer touch panels employ a bridge layer or a complex sector arrangement. With single layer touch panels that use a bridge layer, this layer is used for creating the routing network between the touch sensors and the touch panels periphery or edge. If the bridge layer is formed of a transparent conductive material (such as indium tin oxide), the single layer panel can be more expensive than a dual layer touch panel, and if the bridge layer is formed of an opaque material, it is visible to a user. Complex sector arrangements, on the other hand, can have large number of channels. For example with 6 column and 10 row sensor regions or sectors, 60 separate channels would be used. Moreover, resolution with these systems is low, meaning that most conventional single layer touch panels are limited to single or dual touch capability.

Therefore, there is a need for a single layer touch panel that has multi-touch capability.

Some examples of other conventional systems are: U.S. Pat. No. 6,188,391; U.S. Patent Pre-Grant Publ. No. 2006/0097991; U.S. Patent Pre-Grant Publ. No. 2009/0091551; U.S. Patent Pre-Grant Publ. No. 2010/0149108; U.S. Patent Pre-Grant Publ. No. 2010/0156810; U.S. Patent Pre-Grant Publ. No. 2010/0321326; and PCT Publ. No. WO2009046363.

### SUMMARY

An embodiment of the present invention, accordingly, provides an apparatus. The apparatus comprises a substrate; a cover plate that is substantially transparent to visible spectrum light; a conductive layer formed on at least one of the substrate and the cover plate, wherein the conductive layer is substantially transparent to visible spectrum light, wherein the conductive layer includes: a plurality of row electrodes; a plurality of sets of column electrodes, wherein each set of column electrodes is interleaved with its associated row electrode from the plurality of row electrodes, and a routing network that is coupled to each row electrode and each column electrode; an insulating layer that is formed between the substrate and the cover plate so as to separate each row electrode from each column electrode within its associated set of column electrodes; and a plurality of pads, wherein each pad is secured to at least one of the substrate and cover plate, and wherein each pad is coupled to the routing network, and wherein each pad is located along the periphery of at least one of the substrate and cover plate.

In accordance with an embodiment of the present invention, the conductive layer is formed on the substrate.

In accordance with an embodiment of the present invention, the conductive layer is formed on the cover plate.

In accordance with an embodiment of the present invention, the apparatus further comprises an interconnect that is secured to at least one of the substrate and cover plate and that is coupled to each pad.

In accordance with an embodiment of the present invention, each column electrode is substantially rectangular.

In an accordance with an embodiment of the present invention, in each column electrode is substantially diamond shaped.

In accordance with an embodiment of the present invention, the plurality of pads further comprises a plurality of sets of pads, and wherein each set of pads includes: a row pad that is coupled to its associated row through the routing network; and a plurality of column pads that are coupled to its set of column electrodes through the routing network.

In accordance with an embodiment of the present invention, the conductive layer is formed of a transparent conductive oxide.

In accordance with an embodiment of the present invention, the transparent conductive oxide is indium tin oxide (ITO).

In accordance with an embodiment of the present invention, sets of column electrodes are arranged in an alternating pattern.

In accordance with an embodiment of the present invention, an apparatus is provided. The apparatus comprises a touch panel having: a substrate; a cover plate that is substantially transparent to visible spectrum light; a conductive layer formed on at least one of the substrate and the cover plate, wherein the conductive layer is substantially transparent to visible spectrum light, wherein the conductive layer includes: a plurality of row electrodes; a plurality of sets of column electrodes, wherein each set of column electrodes is interleaved with its associated row electrode from the plurality of row electrodes, and a routing network that is coupled to each row electrode and each column electrode; an insulating layer that is formed between the substrate and the cover plate so as to separate each row electrode from each column electrode within its associated set of column electrodes; and a plurality of pads, wherein each pad is secured to at least one of the substrate and cover plate, and wherein each pad is coupled to the routing network, and wherein each pad is located along the periphery of the touch panel; an interconnect that is secured to the touch panel and that is coupled to each pad; and a touch panel controller that is coupled to the interconnect.

In accordance with an embodiment of the present invention, the touch screen controller is configured to detect three or more touch events.

In accordance with an embodiment of the present invention, an apparatus is provided. The apparatus comprises a touch panel having a plurality of sensors arranged in a plurality of rows and columns, wherein each row has a row electrode that extends across a portion of the touch screen and that is coupled to a row pad located along the periphery of the touch panel through a routing network, and wherein each column has a plurality of column electrodes that are interleaved with at least one of the row electrodes and that are each coupled to a column pad located along the periphery of the touch panel through the routing network, and wherein each row electrode and each column electrode are formed of a transparent conductive material and separated by an insulating material; an interconnect that is secured to the touch panel and that is coupled to each column pad and each row pad; and a touch screen controller having: an interface that is coupled to the interconnect; and a control circuit that is coupled to the interface.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1 and 2 are diagrams of an example of a conventional system;

FIG. 3 is a diagram of an example of a system in accordance with an embodiment of the present invention;

FIG. 4 is a diagram of an example of a touch panel of FIG. 3;

FIGS. 5 and 6 are examples of cross-sectional views of the touch panel along section line I-I;

FIGS. 7, 8, and 9 are examples of cross-sectional views of the touch panel along section line II-II;

FIG. 10 is a diagram of an example of the interconnect of FIG. 3;

FIG. 11 is a diagram of an example of a touch panel of FIG. 3;

FIG. 12 is a diagram of an example of the interconnect of FIG. 3; and

FIGS. 13 and 14 are examples of a diamond pattern used for the touch panel of FIG. 3.

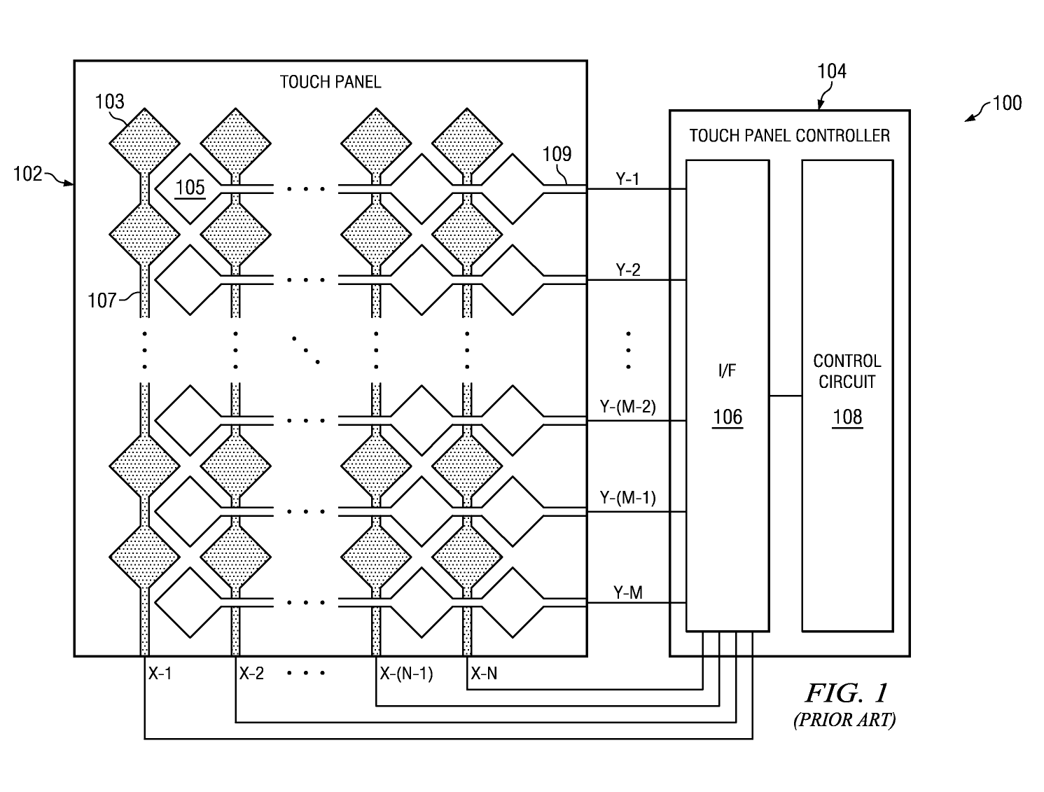

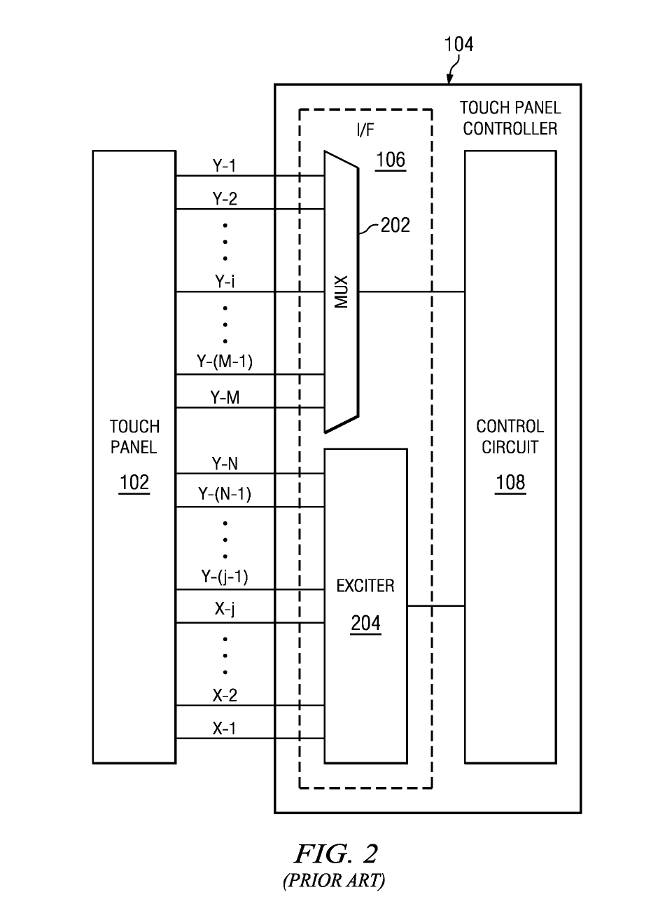

### DETAILED DESCRIPTION

Refer now to the drawings wherein depicted elements are, for the sake of clarity, not necessarily shown to scale and wherein like or similar elements are designated by the same reference numeral through the several views.

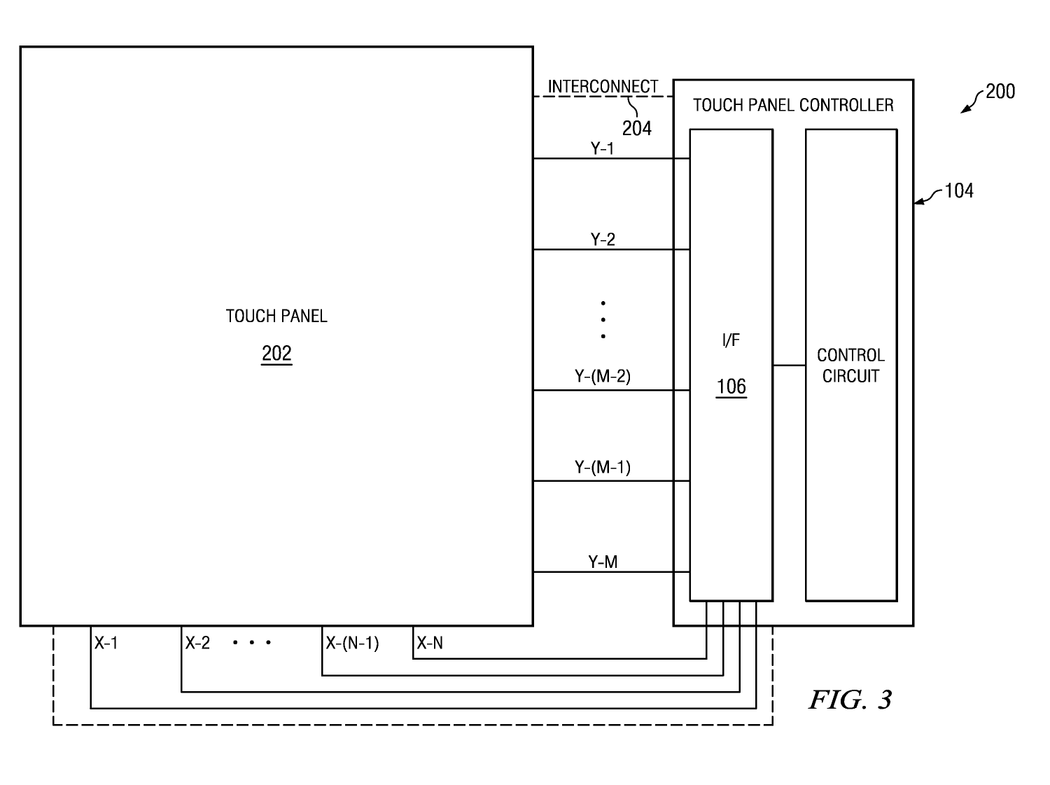

Turning to FIG. 3, an example of a system 200 in accordance with an embodiment of the present invention can be seen. System 200 is similar in construction to system 100 except that touch panel 102 has been replaced by touch panel 202. Additionally, interconnect 204 has been provided to provide communication channels between the touch panel controller 104 and the touch panel 202.

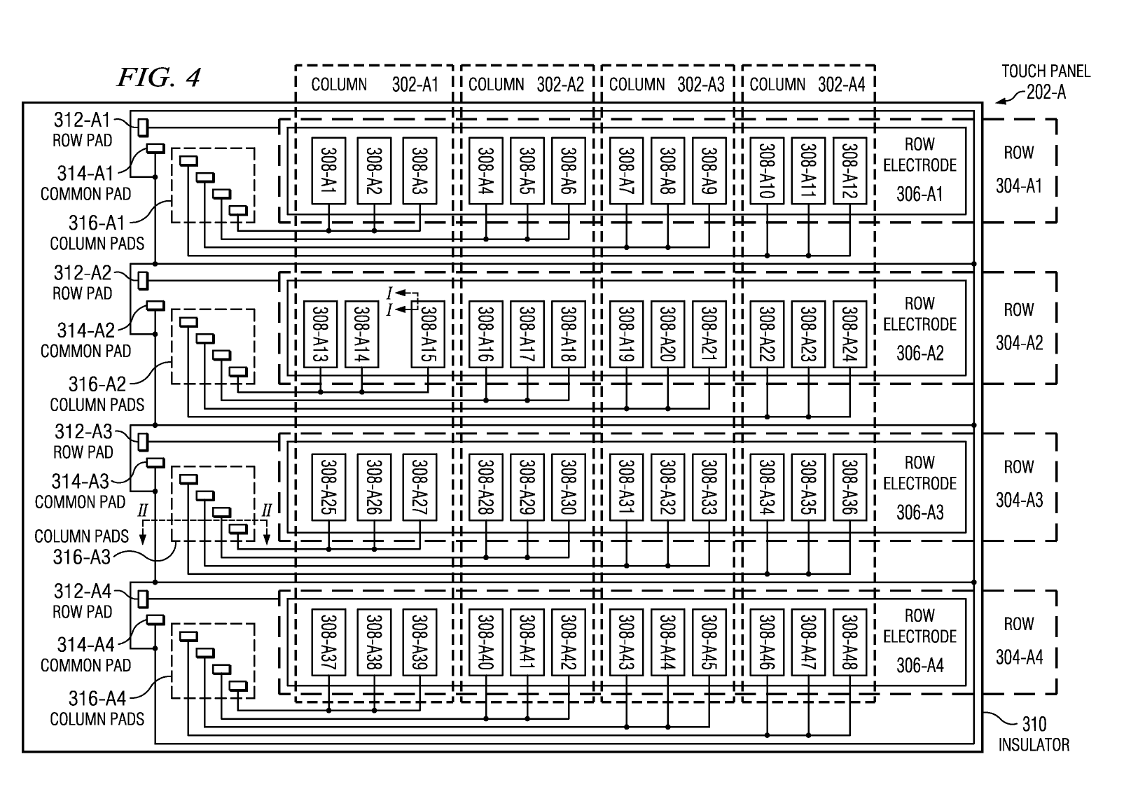

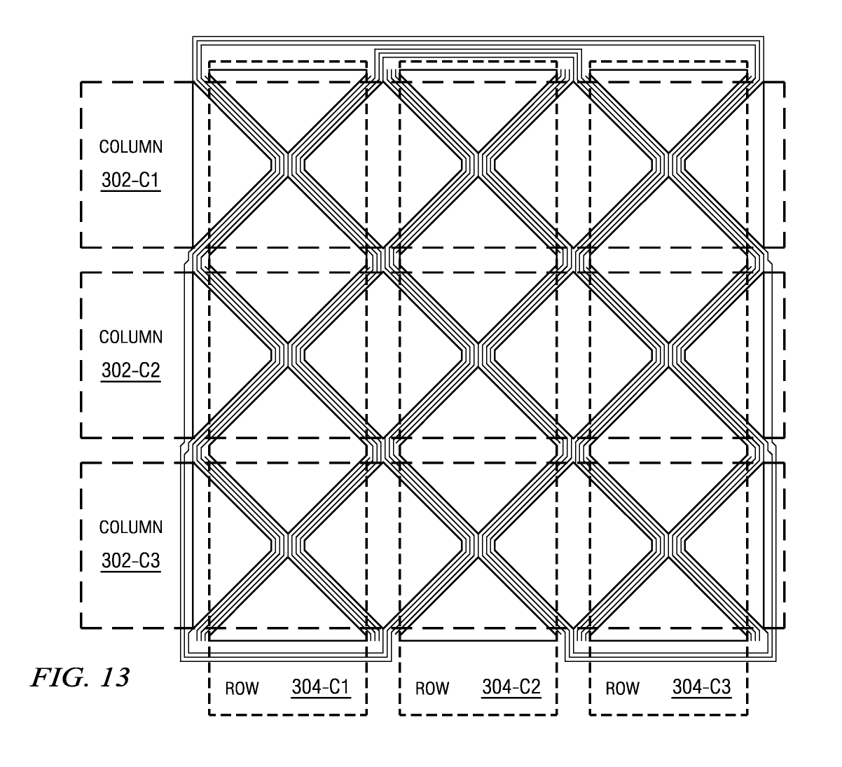

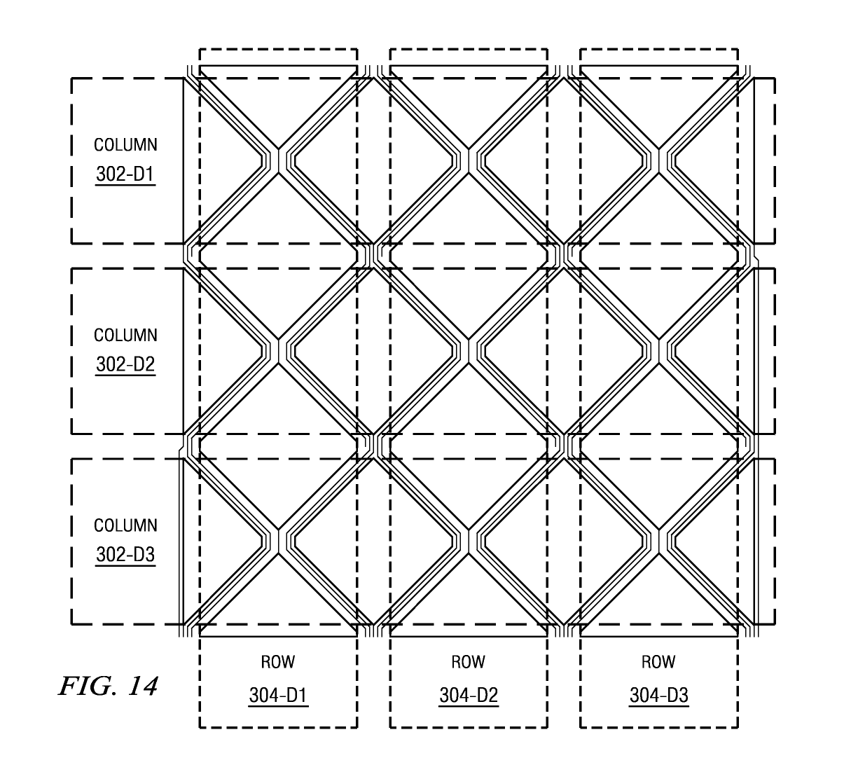

In FIG. 4, an example of the touch panel 202 (which is labeled 202-A for FIG. 4) can be seen in greater detail. As shown in this example, touch panel 202-A a 4 by 4 array of sensors, but other numbers of sensors (such as 6×6, 8×8, or 6×10) may be possible. Rows 304-A1 to 304-A2 each have a row electrode 306-A1 to 306-A4, respectively, that extend across the touch panel 202-A and that are generally parallel to on another. While these row electrodes 306-A1 to 306-A4 are shown to be substantially rectangular with notches (or “comb-shaped”) other shapes (such as “wavy” shapes) may also be possible. Each of these row electrodes 306-A1 to 306-A4 is coupled to row pad 312-A1 to 312-A4, respectively, through the routing network. Each column 302-A1 to 302-A4 includes a set of sensors (in this example three) associated with each row 304-A1 to 304-A4. As shown, the column electrodes 308-A1 to 308-A12, 308-A13 to 308-A24, 308-A25 to 308-A36, and 308-A37 to 308-A48 are, respectively, interleaved with row electrodes 306-A1 to 306-A4 and are, respectively, coupled to column pads 316-A1 to 316-A4 (at the end of each row 306-A1 to 306-A4) through common routing channels (which is part of the routing network). These electrodes 308-A1 to 308-A48, too, as shown to have substantially rectangular shapes, but other shapes (such as diamonds shown columns 302-C1 to 302-C3 and 302-D1 to 302-D3 and rows 304-C1 to 304-C3 and 304-D1 to 304-D3 of FIGS. 13 and 14) may also be employed. Additionally, separating the row electrodes 306-A1 and 306-A4 from each other and from column electrodes 308-A1 to 308-A48 is an insulator 310, and the row electrodes 306-A1 and 306-A4 and column electrodes 308-A1 to 308-A48 are also generally formed of a conductive material that is generally transparent to visible spectrum light (such as indium tin oxide, aluminum doped zinc oxide, gallium doped zinc oxide, or indium doped zinc oxide). This configuration also allows for a borderless on up to three sides implementation of the sensor region. Additionally and alternatively, it may be desirable to route column electrode to opposing ends of the touch panel 202-A. As an example, it is frequently desirable to route one-half of the column sensors from one side of the column and the rest to the other side of the column. Adjacent rows may also be flipped in an alternating pattern (which allows looping at one end for reduced complexity).

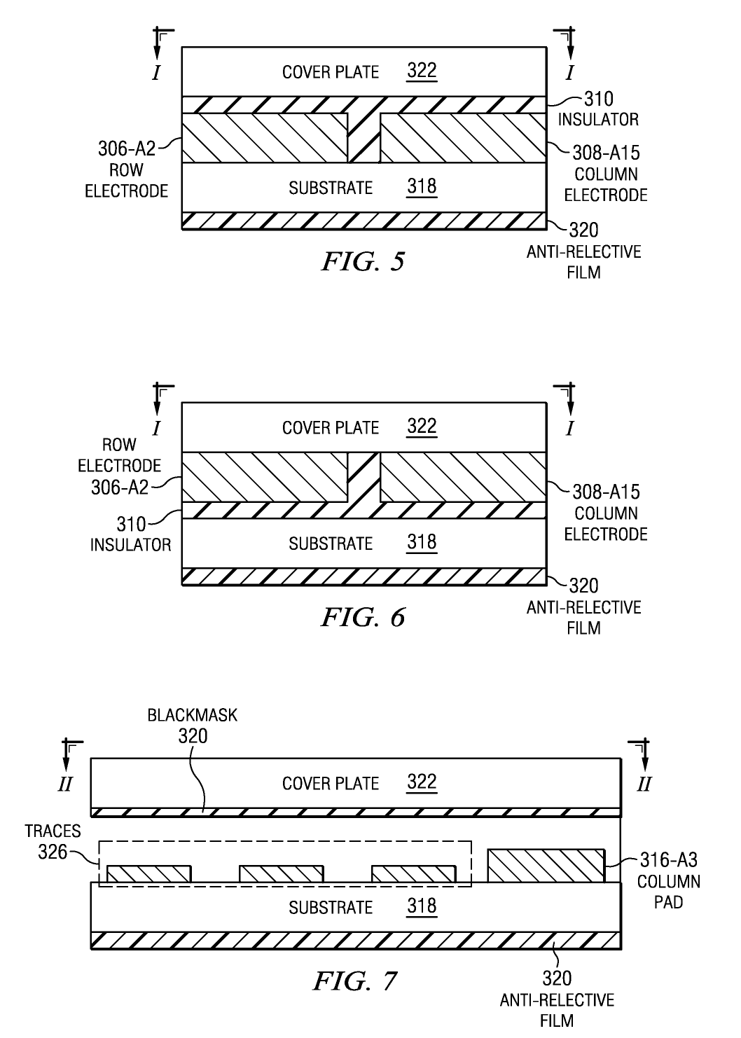

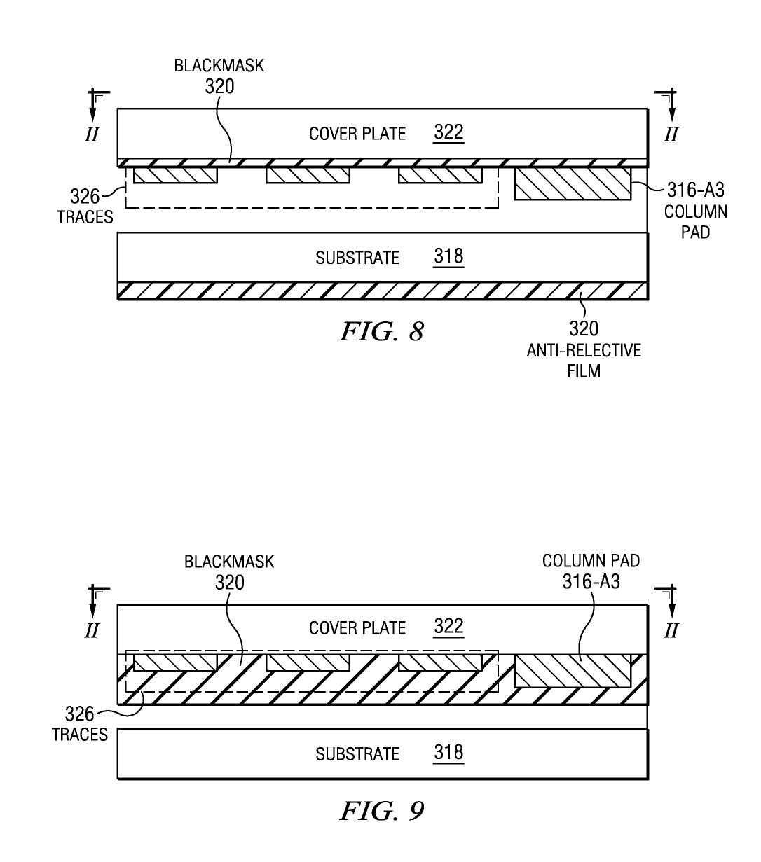

There are several ways to layer the touch panel 202-A. Typically, touch panel 202-A is formed with the sensor layer(s) sandwiched between a substrate 318 and cover plate 322. The electrodes (namely, row electrodes 306-A1 to 306-A4 and column electrodes 308-A1 to 308-A48) are formed on either the substrate 318 (as shown in FIG. 5) or the cover plate 322 (as shown in FIG. 6), usually by electron beam evaporation, physical vapor deposition (PVD), or sputter deposition. When the electrodes are formed on the cover plate 322, this can be accomplished by applying a generally uniform layer of the conductive material and performing a laser ablation to remove portions of the layer. An adhesive (such as an epoxy) can they be used as the insulating material for insulator 310 to secure the cover plate 322 and substrate 318 together. Additionally, the substrate 318 can include illumination elements (i.e., light emitting diodes or LEDs) or can be a transparent plate and may also include an anti-reflective coating or film 320. Similarly, row pads 312-A1 to 312-A4, common pads 314-A1 to 314-A4, column pads 316-A1 to 316-A4, and traces 326 (which are part of the routing network) can be secured to or formed on the substrate 318 (as shown in FIG. 7) or the cover plate 322 (as shown in FIG. 8) along the periphery of the touch panel 202-A. Also, along the periphery of the touch panel 202-A the cover plate 322 can include blackmask layer 320 to hide these features from view of the user. This blackmask layer 320 can located between the row pads 312-A1 to 312-A4, common pads 314-A1 to 314-A4, column pads 316-A1 to 316-A4, and traces 326 (as shown in FIG. 8) or over the row pads 312-A1 to 312-A4, common pads 314-A1 to 314-A4, column pads 316-A1 to 316-A4, and traces 326 (as shown in FIG. 9).

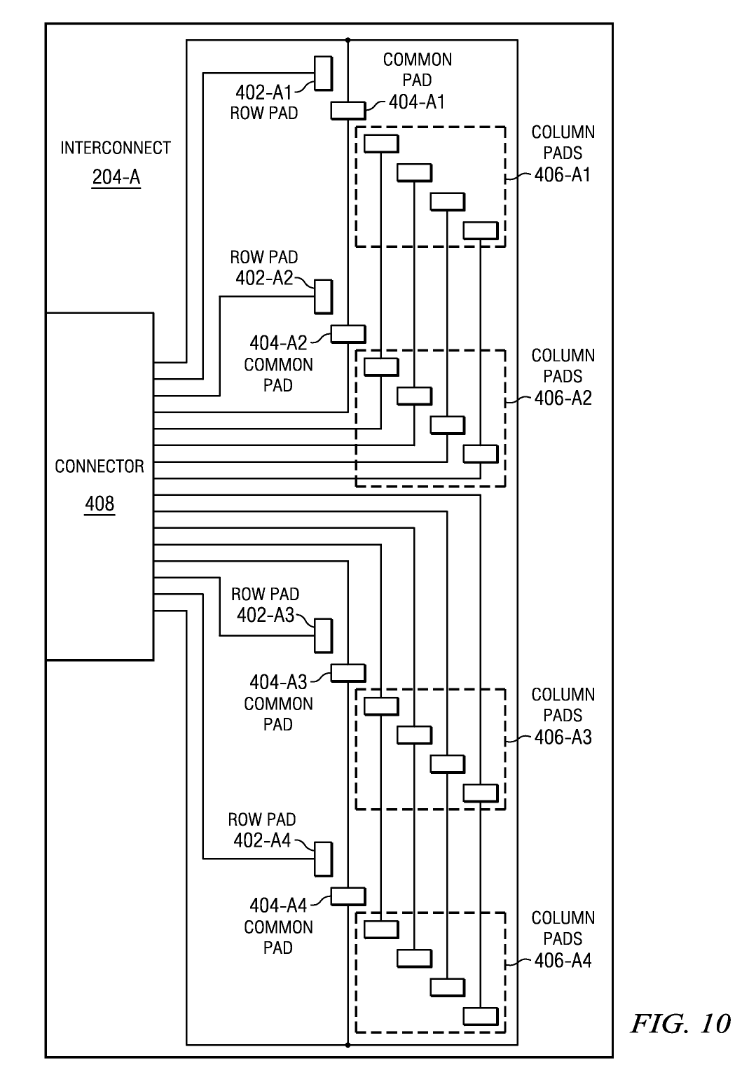

As shown in FIG. 4, the row pads 312-A1 to 312-A4, common pads 314-A1 to 314-A4, and column pads 316-A1 to 316-A4 for each row 306-A1 to 306-A4 are arranged in a cascaded arrangement. This cascaded arrangement allows for direct connections (no crossovers) between the touch panel 202-A and connector 408 on interconnect 204-A (which can be seen in FIG. 10). Typically, this interconnect 204-A is secured to touch panel 202-A along its periphery so that row pads 402-A1 to 402-A4, common pads 404-A1 to 404-A4, and column pads 406-A1 to 406-A4 can be respectively coupled to row pads 312-A1 to 312-A4, common pads 314-A1 to 314-A4, and column pads 316-A1 to 316-A4. In this method, the column connection traces also run parallel to the rows and connect to the appropriate column sensor region.

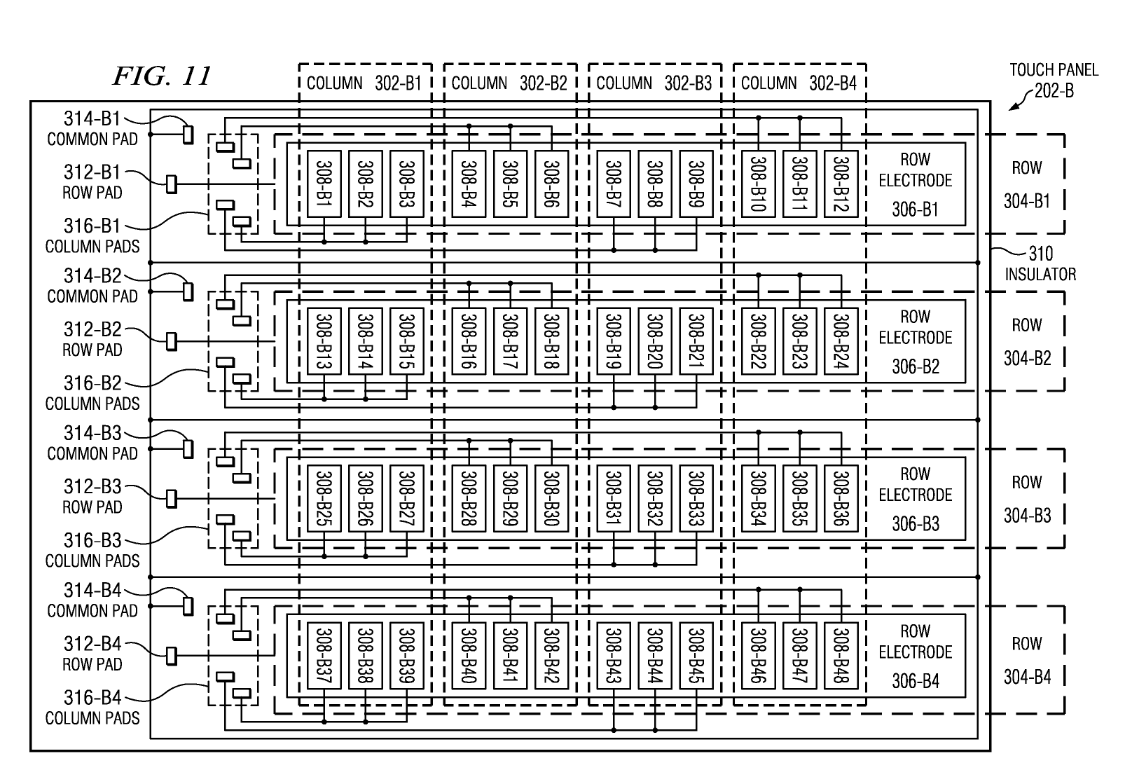

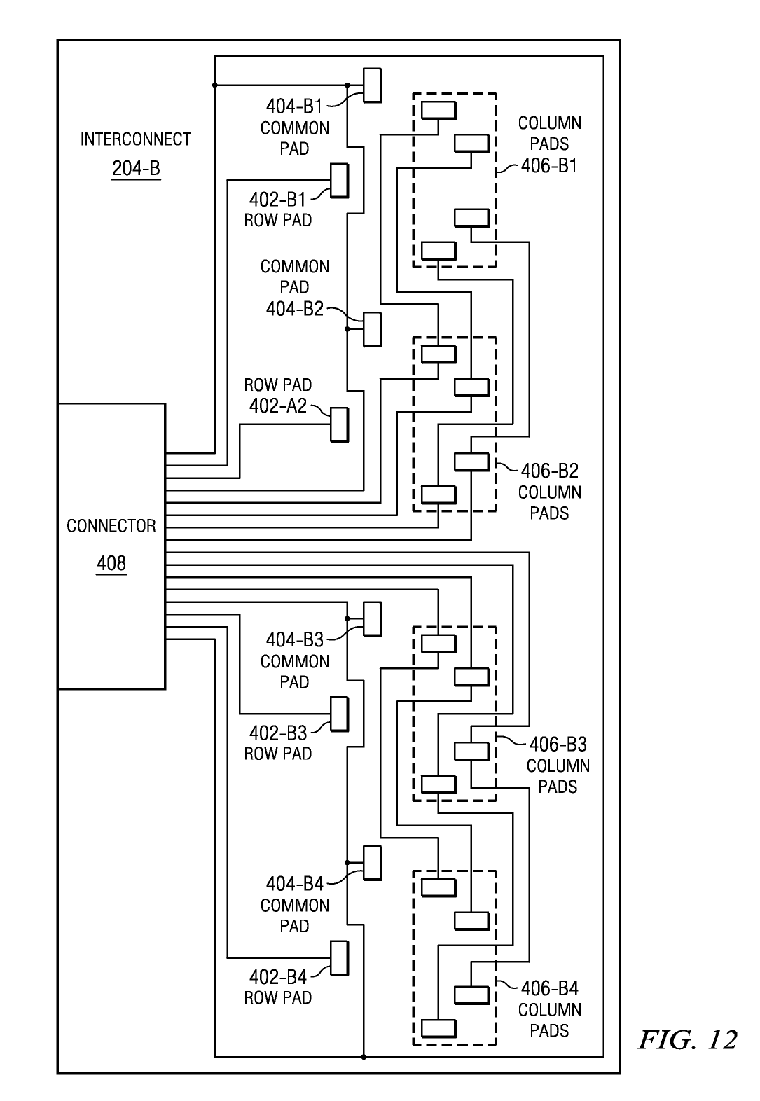

Turning now to FIGS. 11 and 12, another example configuration for the touch panel 202 (which is labeled 202-B) can be seen. In this configuration, the column electrodes 308-B1 to 308-B2 are interleaved (similar to column 308-A1 to 308-A48) and alternating so as to use multiple routing channels (within the routing network) for each row 304-B1 to 304-B2. As shown in this example, columns 302-B2 and 302-B4 use the “top” routing channel, while columns 302-B1 and 302-B2 use the “bottom” routing channels. Other configurations may also be possible. As a result of using this configuration, another pattern is generally used for common pads 314-B1 to 314-B4, row pads 312-B1 to 312-B4, and column pads 316-B1 to 316-B2 (and the corresponding common pads 404-B1 to 404-B4, row pads 402-B1 to 402-B4, and column pads 406-B1 to 406-B2 for interconnect 204-B) that allow for direct connection between the touch panel 202-B and connector 408 in interconnect 204-B.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1. An apparatus comprising:
a substrate;
a cover plate that is substantially transparent to visible spectrum light;
a conductive layer formed on at least one of the substrate and the cover plate, wherein the conductive layer is substantially transparent to visible spectrum light, wherein the conductive layer includes:
a plurality of row electrodes;
a plurality of sets of column electrodes, wherein each set of column electrodes is interleaved with its associated row electrode from the plurality of row electrodes, and
a routing network that is coupled to each row electrode and each column electrode;
an insulating layer that is formed between the substrate and the cover plate so as to separate each row electrode from each column electrode within its associated set of column electrodes; and
a plurality of pads, wherein each pad is secured to at least one of the substrate and cover plate, and wherein each pad is coupled to the routing network, and wherein each pad is located along the periphery of at least one of the substrate and cover plate.

2. The apparatus of claim 1, wherein the conductive layer is formed on the substrate.

3. The apparatus of claim 1, wherein the conductive layer is formed on the cover plate.

4. The apparatus of claim 1, wherein the apparatus further comprises an interconnect that is secured to at least one of the substrate and cover plate and that is coupled to each pad.

5. The apparatus of claim 4, wherein each column electrode is substantially rectangular.

6. The apparatus of claim 5, wherein the plurality of pads further comprises a plurality of sets of pads, and wherein each set of pads includes:
a row pad that is coupled to its associated row through the routing network; and
a plurality of column pads that are coupled to its set of column electrodes through the routing network.

7. The apparatus of claim 6, wherein the conductive layer is formed of a transparent conductive oxide.

8. The apparatus of claim 7, wherein the transparent conductive oxide is indium tin oxide (ITO).

9. The apparatus of claim 6, wherein sets of column electrodes are arranged in an alternating pattern.

10. An apparatus comprising:
a touch panel having:
a substrate;
a cover plate that is substantially transparent to visible spectrum light;
a conductive layer formed on at least one of the substrate and the cover plate, wherein the conductive layer is substantially transparent to visible spectrum light, wherein the conductive layer includes:
a plurality of row electrodes;
a plurality of sets of column electrodes, wherein each set of column electrodes is interleaved with its associated row electrode from the plurality of row electrodes, and
a routing network that is coupled to each row electrode and each column electrode;
an insulating layer that is formed between the substrate and the cover plate so as to separate each row electrode from each column electrode within its associated set of column electrodes; and
a plurality of pads, wherein each pad is secured to at least one of the substrate and cover plate, and wherein each pad is coupled to the routing network, and wherein each pad is located along the periphery of the touch panel;
an interconnect that is secured to the touch panel and that is coupled to each pad; and
a touch panel controller that is coupled to the interconnect.

11. The apparatus of claim 10, wherein the conductive layer is formed on the substrate.

12. The apparatus of claim 10, wherein the conductive layer is formed on the cover plate.

13. The apparatus of claim 10, wherein each column electrode is substantially rectangular.

14. The apparatus of claim 10, wherein each column electrode is substantially diamond shaped.

15. The apparatus of claim 13, wherein the plurality of pads further comprises a plurality of sets of pads, and wherein each set of pads includes:
a row pad that is coupled to its associated row through the routing network; and
a plurality of column pads that are coupled to its set of column electrodes through the routing network.

16. The apparatus of claim 15, wherein the conductive layer is formed of ITO.

17. The apparatus of claim 16, wherein the touch screen controller is configured to detect three or more touch events.

18. The apparatus of claim 15, wherein sets of column electrodes are arranged in an alternating pattern.

19. An apparatus comprising:
a touch panel having a plurality of sensors arranged in a plurality of rows and columns, wherein each row has a row electrode that extends across a portion of the touch screen and that is coupled to a row pad located along the periphery of the touch panel through a routing network, and wherein each column has a plurality of column electrodes that are interleaved with at least one of the row electrodes and that are each coupled to a column pad located along the periphery of the touch panel through the routing network, and wherein each row electrode and each column electrode are formed of a transparent conductive material and separated by an insulating material;
an interconnect that is secured to the touch panel and that is coupled to each column pad and each row pad; and
a touch screen controller having:
an interface that is coupled to the interconnect; and
a control circuit that is coupled to the interface.

20. The apparatus of claim 19, wherein the transparent conductive material is ITO.

21. The apparatus of claim 20, wherein sets of column electrodes are arranged in an alternating pattern.
